(19) United States
(12) Patent Application Publication
(10) Pub. No.: US 2006/0199645 A1
(43) Pub. Date: Sep. 7, 2006

(54) WAGERING GAME WITH STREAMING USB AUDIO

(76) Inventors: Stephen A. Canterbury, Antioch, IL (US); Victor Mercado, Berwyn, IL (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/276,285

(22) Filed: Feb. 22, 2006

Related U.S. Application Data
(60) Provisional application No. 60/657,036, filed on Feb. 28, 2005.

(51) Int. Cl. A63F 13/00

(52) U.S. Cl. 463/43; 463/46

(57) ABSTRACT

A computerized wagering game system includes a gaming module comprising a processor and gaming code which is operable when executed on the processor to present a wagering game on which monetary value can be wagered. The computerized wagering game further includes a Universal Serial Bus (USB) port, and a USB audio module coupled to the gaming module via the USB port that is operable to receive streaming audio from the gaming module and to play the streaming audio through at least one audio channel that is coupled to a speaker operable to play sound.

### RELATED APPLICATION

This application claims priority under 35 U.S.C. 119(e) from U.S. Provisional Application Ser. No. 60/657,036 filed Feb. 28, 2005, which application is incorporated herein by reference.

### FIELD OF THE INVENTION

The invention relates generally to computerized wagering game machines, and more specifically computerized wagering game machines having USB audio.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever. Copyright 2005, WMS Gaming, Inc.

### BACKGROUND

Computerized wagering games have largely replaced traditional mechanical wagering game machines such as slot machines, and are rapidly being adopted to implement computerized versions of games that are traditionally played live such as poker and blackjack. These computerized games provide many benefits to the game owner and to the gambler, including greater reliability than can be achieved with a mechanical game or human dealer, more variety, sound, and animation in presentation of a game, and a lower overall cost of production and management.

The elements of computerized wagering game systems are in many ways the same as the elements in the mechanical and table game counterparts in that they must be fair, they must provide sufficient feedback to the game player to make the game fun to play, and they must meet a variety of gaming regulations to ensure that both the machine owner and gamer are honest and fairly treated in implementing the game. Further, they must provide a gaming experience that is at least as attractive as the older mechanical gaming machine experience to the gamer, to ensure success in a competitive gaming market.

Computerized wagering games do not rely on the dealer to facilitate game play and to provide an entertaining game playing environment, but rely upon the presentation of the game and environment generated by the wagering game machine itself. Incorporation of audio and video features into wagering games to present the wagering game, to provide help, and to enhance the environment presented are therefore important elements in the attractiveness and commercial success of a computerized wagering game system. It is not uncommon for audio voices to provide instruction and help, and to provide commentary on the wagering game being played. Music and environmental effects are also played through speakers in some wagering game systems to enhance or complement a theme of the wagering game. These sounds typically accompany video presentation of the wagering game on a screen, which itself often includes animation, video, and three-dimensional graphics as part of presentation of the wagering game.

But, the audio environment created by presenting even such a complex variety of sounds through a speaker or pair of speakers mounted on a wagering game machine is limited, especially relative to home theater systems and actual acoustic environments. It is therefore desired to be able to adapt a computerized wagering game machine to have greater audio capabilities, and to be able to present a more sophisticated audio environment to a wagering game player.

### SUMMARY

One example embodiment of the invention comprises a computerized wagering game system including a gaming module comprising a processor and gaming code which is operable when executed on the processor to present a wagering game on which monetary value can be wagered. The computerized wagering game further includes a Universal Serial Bus (USB) port, and a USB audio module coupled to the gaming module via the USB port that is operable to receive streaming audio from the gaming module and to play the streaming audio through at least one audio channel that is coupled to a speaker operable to play sound.

### BRIEF DESCRIPTION OF THE FIGURES

FIG. 1 shows a computerized wagering game system as may be used to practice some embodiments of the present invention.

FIG. 2 shows a computerized wagering game system featuring a streaming audio USB device, consistent with an example embodiment of the present invention.

FIG. 3 is a flowchart illustrating a method of providing audio in a computerized wagering game machine via a streaming audio USB device, consistent with an example embodiment of the present invention.

FIG. 4 shows a computerized wagering game incorporating an audio chair assembly and having a streaming audio USB device, consistent with an example embodiment of the present invention.

FIG. 5 is a block diagram of a computerized wagering game incorporating an audio chair assembly and having a streaming audio USB device, consistent with an example embodiment of the present invention.

FIG. 6 is a block diagram of a computerized wagering game system with an external speaker enclosure, consistent with an example embodiment of the present invention.

### DETAILED DESCRIPTION

In the following detailed description of example embodiments of the invention, reference is made to specific examples by way of drawings and illustrations. These examples are described in sufficient detail to enable those skilled in the art to practice the invention, and serve to illustrate how the invention may be applied to various purposes or embodiments. Other embodiments of the invention exist and are within the scope of the invention, and logical, mechanical, electrical, and other changes may be made without departing from the subject or scope of the present invention. Features or limitations of various embodiments of the invention described herein, however essential to the example embodiments in which they are incorporated, do not limit the invention as a whole, and any reference to the invention, its elements, operation, and application do not limit the invention as a whole but serve only to define these example embodiments. The following detailed description does not, therefore, limit the scope of the invention, which is defined only by the appended claims.

One example embodiment of the invention comprises a computerized wagering game system, including a gaming module comprising a processor and gaming code which is operable when executed on the processor to present a wagering game on which monetary value can be wagered. The computerized wagering game further includes a Universal Serial Bus (USB) port, and a USB audio module coupled to the gaming module via the USB port that is operable to receive streaming audio from the gaming module and to play the streaming audio through at least one audio channel that is coupled to a speaker operable to play sound. Other embodiments include a USB streaming audio module operable when coupled to a computerized wagering game machine to receive and play streaming audio, and a method and machine-readable medium having instructions for playing streaming audio in a computerized wagering game through a streaming audio USB device.

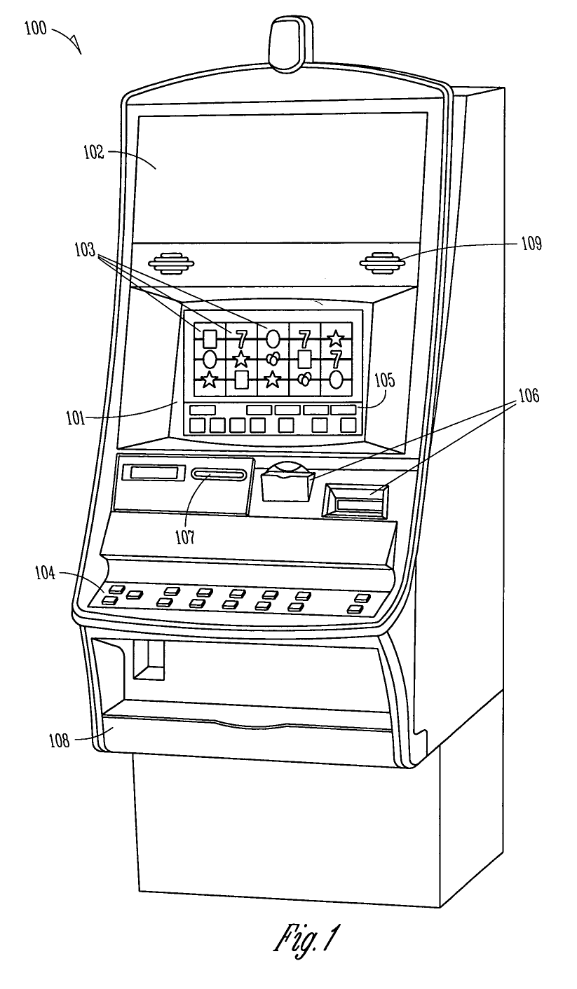

FIG. 1 illustrates a computerized wagering game machine, as may be used to practice some embodiments of the present invention. The computerized gaming system shown generally at 100 is a video gaming system, which displays information for at least one wagering game upon which monetary value can be wagered on video display 101. In a further embodiment, additional displays such as top-box display 102 are also used. Alternate embodiments of the invention will have other game indicators, such as mechanical reels instead of the video graphics reels 103.

The wagering game is played and controlled in various embodiments with buttons 104, via a touchscreen display 101, and in some slot machine embodiments also with a pull arm to initiate reel spin. Examples of wagering games that may be played on such a computerized wagering game machine include slot machine games, video poker, video blackjack, keno, craps, or any other such game or event.

Value is wagered on the games, such as with tokens, coins, bills, or cards that hold value. The wagered value is conveyed to the machine through a changer 106 or a secure user identification module interface 107 such as a smart card reader or other interface, and winnings are returned via a returned value card or through the coin tray 108.

Sound is provided through a single speaker or multiple speakers 109. A single speaker is not capable of playing stereo or surround sound, but in some example computerized wagering games two or more speakers are configured to play stereo or surround sound audio. Although surround sound can be simulated with two speakers, use of three or more speakers is required for many surround sound formats.

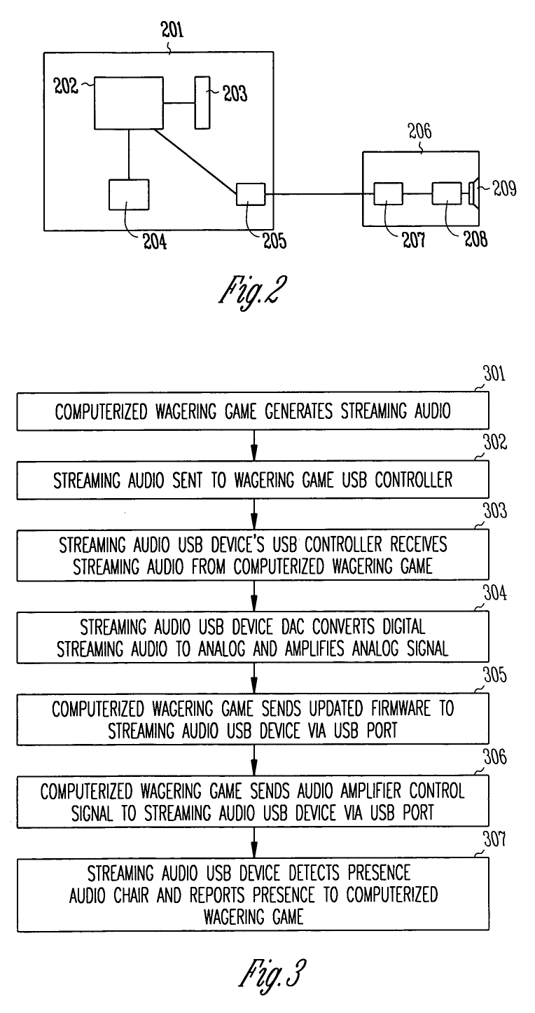

One way to provide true surround sound is to couple additional audio channels and speakers to the computerized wagering game system. One example embodiment of the invention provides a mechanism by which additional speakers can be attached to the computerized wagering game system by use of a streaming audio USB device, as shown in FIG. 2. A computerized wagering game printed circuit board 201 contains a processor 202 operable to execute computer instructions, and to conduct a wagering game upon which monetary value can be wagered. The processor is coupled to memory 203, in which data is stored during operation of the computerized wagering game. An audio processor 204 such as an audio coder/decoder (codec) 204 is coupled to the processor such as by a computer bus, and a universal serial bus (USB) controller 205 is coupled to the processor 202 by a similar bus or other connection.

The audio codec 204 produces sound at the direction of the processor 202, and the sound is played through speakers such as speakers 108 of FIG. 1. Sound is also sent to an external streaming audio USB device 206 via the USB controller 205, and is received via the USB controller 207 of the streaming audio USB controller. The received streaming audio signal is then sent to an amplifier 208, which is coupled to a speaker 209.

The processor 202 need not be involved in transferring streaming audio data from the audio processor 204 to the USB controller 205, which in some embodiments uses direct memory access (DMA) to transfer data from the audio processor 204 to the USB controller 205 without the processor facilitating transfer of each byte of data. The streaming audio signal is provided continuously to the USB controller 205, which continuously provides the streaming audio signal to the streaming audio USB controller via the USB connection.

The streaming audio is in some embodiments multichannel or surround sound audio, as is often used to enhance the acoustic environment of movies shown in movie theaters and in home theater systems. A few example commercial embodiments are discussed here in greater detail (all names are trademarked property of their respective owners). Examples include Dolby formats such as Dolby ProLogic and Dolby Digital, Logic 7, and various embodiments of DTS such as DTS-ES and DTS-NEO6.

Dolby ProLogic was one of the first commercially available surround sound formats, and enabled analog derivation of a center channel and two surround channels from a two-channel encoded signal. Dolby Digital is a digitally encoded format, providing for encoding and decoding of five full-range channels and a low frequency channel (5.1 channels) from an encoded digital signal.

Similarly, a variety of digital surround sound formats from DTS, including DTS, DTS-ES, and DTS-NEO6 derive five or six channels plus a low frequency effects channel from a digitally encoded signal. DTS is a five channel discrete encoded signal that also has an encoded low frequency effects channel. DTS-ES adds a sixth channel, plus the ability to matrix encode a 5.1 channel surround signal in addition to discrete channel encoding. DTS-NEO6 is a six channel matrix encoded format, incorporating a low-frequency effects channel to provide a 6.1 channel matrix encoded digital surround format.

Logic 7, also known as L7, is a proprietary seven-channel decoding process developed by Lexicon, a subsidiary of Harman International. Logic 7 in various embodiments is able to derive seven channel surround sound from a two channel stereo or matrix encoded source, and has various parameters optimized for film, broadcast, reverberant environment, and other modes. It is further able to derive up to seven channels of surround information from other surround encoded formats, including matrix and discrete multichannel surround formats such as Dolby Digital or DTS.

The Dolby Digital, Logic 7, DTS, and other surround sound formats presented here are examples of surround sound or multichannel audio systems which will benefit in various computerized wagering game embodiments from the addition of one or more channels of audio via a streaming audio USB device. Such surround sound speaker systems are able to enhance presentation of the environmental audio effects by providing different sound from several directions at once, thereby reproducing an acoustic environment more accurately. The surround sound audio system will take various forms in various embodiments, including incorporation into a chair in which the wagering game player sits.

FIG. 3 is a flowchart, illustrating a method of providing audio in a computerized wagering game machine via a streaming audio USB device, including management of surround audio channel amplifiers and detection of an audio chair device having one or more speakers mounted therein. At 301, the computerized wagering game generates streaming audio in response to commands from the code executing in the computerized wagering game system. The streaming audio is in some embodiments a single primary audio channel or a stereo pair of main audio channels, and are the primary sounds produced by the wagering game machine. In other embodiments, the sounds produced are surround sound or effects audio channels produced in addition to one or more other audio channels produced by the wagering game machine.

The streaming audio channels produced at 301 are sent to a USB controller within the wagering game at 302. The streaming audio can be encoded in various formats, such as SPDIF, AES/EBU, I2S, right or left-justified PCM, or any other such digital audio format. In alternate embodiments, the audio is compressed or coded via a lossless encoding method, such as a Rice code, Meridian lossless packing, FLAC, or another such code. Lossy compression is utilized in still other embodiments, such as where Dolby Digital (AC3), DTS, or other such coding methods are used. The coded audio is received in the USB controller and sent as streaming data via the USB port to an attached streaming audio USB device, which receives the streaming audio from the computerized wagering game system at 303.

The streaming audio USB device's USB controller receives the streaming data and outputs the data to a digital-to-analog converter at 304. In some embodiments, the digital-to-analog converter is a part of an audio codec or audio processor operable to perform other functions, such as to decompress or decode various formats of streaming audio data. The analog output of the digital-to-analog converter or of the audio processor is then routed to an audio amplifier that amplifies the audio signal and sends it to a speaker that produces audible sound in response. In still other embodiments of the streaming audio USB device, the digital data is not converted to analog, but is sent to a digital amplifier module as a digital audio signal. The digital amplifier then amplifies and filters the digital audio signal and sends its output to a speaker that produces sound in response to the applied signal.

Operation of elements 301-304 are sufficient to produce sound in this example embodiment of the invention, but additional functions are utilized in various further embodiments to provide additional functionality. At 305, the computerized wagering game sends updated firmware to the streaming audio USB device via the USB port of the wagering game machine. The USB controller of the streaming audio USB device receives the firmware update data, and processes the data such that firmware of a component such as the audio processor, the USB controller, or another processor within the system is updated with the firmware provided. One embodiment includes a programmable audio processor operable to load firmware and execute code that performs audio processing, either in a separate audio processor module or as part of an amplifier module or other component. The USB controller itself executes firmware in some embodiments that enables it to receive and process streaming audio data, and this firmware is upgradable via the USB connection to the computerized wagering game system or other USB device. In some further embodiments, the USB controller is operable to acknowledge receipt of the firmware update, and to confirm that the firmware update process has been completed successfully or to indicate an error in the firmware update process.

At 306, the computerized wagering game sends an amplifier control signal to the streaming audio USB device via the USB connection. In some embodiments, this is a volume control signal operable to set the gain or volume of the audio amplifier. The amplifier control signal is received in the streaming audio USB device's USB controller, and is recognized either in the USB controller or in another processor as being formatted as an amplifier control signal rather than streaming audio data. The amplifier control signal is then routed to audio amplifier control circuitry, such as an analog amplifier gain circuit or a digital amplifier signal scaling circuit. This enables the computerized wagering game system to send a full-resolution or full-scale signal to the streaming audio USB device, and for the volume to be set in the amplifier stage so that signal resolution is not lost before amplification. Embodiments such as this also enable the computerized wagering game system to manage volume controls for each audio channel, such as an absolute volume level that controls all audio channels and relative volume signals that control independent audio channels or groups of audio channels.

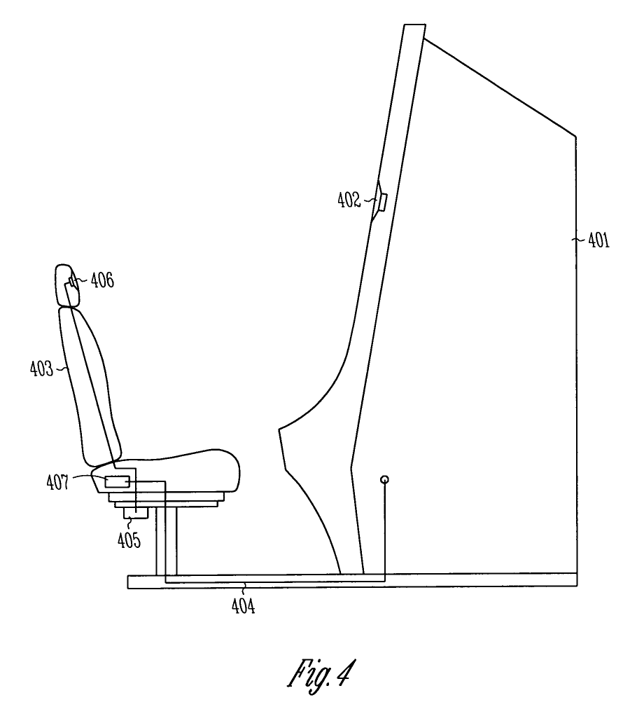

As an example, consider a computerized wagering game system such as that of FIG. 1 in conjunction with an external speaker enclosure such as an audio chair, as is shown in FIG. 4. The computerized wagering game system 401 contains one or more speakers such as speakers 108 of FIG. 1. In this example, it includes front left and right speakers, but no center channel speaker. In other embodiments the computerized wagering game speaker array includes a center speaker, multiple drivers for one or more of the audio channels, or even a single speaker mounted in the computerized wagering game system chassis.

An audio chair assembly 403 is attached to the computerized wagering game system by at least a USB cable 404, which couples a streaming audio USB device 405 to the computerized wagering game system. The streaming audio USB device receives streaming audio data from the computerized wagering game system 401, and converts the received data to an audio signal that is played through speakers 406 and through tactile transducer 407. The speakers 406 comprise one or more speakers coupled to one or more audio channels via the streaming audio USB device 405, which in this embodiment includes an amplifier coupled to a power source and operable to amplify audio signals provided via the streaming audio USB device. The signal provided from the USB streaming audio device to the amplifier is in some embodiments an analog audio signal, and is in other embodiments a digital audio signal such as an SPDIF, PCM, or AES/EBU digital audio signal.

The speakers 406 in one embodiment comprise a pair of wide-range speakers that are coupled to left and right surround sound channels. Each of the two speaker drivers converts one channel of audio into audible sound via the speakers positioned to either side of the chair, so that when a wagering game player is seated in the chair 403 each of the two speakers is configured to provide sound more directly to one game player's ear or the other. In one further embodiment, audio data for the rear two audio channels of a surround sound-encoded format are routed to the two speakers 406 mounted in the audio chair 403 or other external enclosure, enabling reproduction of an enveloping acoustic environment via the additional speakers 406 and the streaming audio USB device 405.

The tactile transducer 407 is further incorporated into the audio chair in some embodiments, and provides low-frequency effects to a game player seated in the chair 403 by vibrating the chair in response to low frequency audio information provided via the streaming audio USB device 405. Although the low frequency effects coupled to a tactile transducer will produce relatively low acoustic sound pressure levels and be difficult to hear, the sensation the game player experiences in feeling the chair shaking at bass frequencies contributes to the sensation of bass with minimal disturbance to neighboring game players.

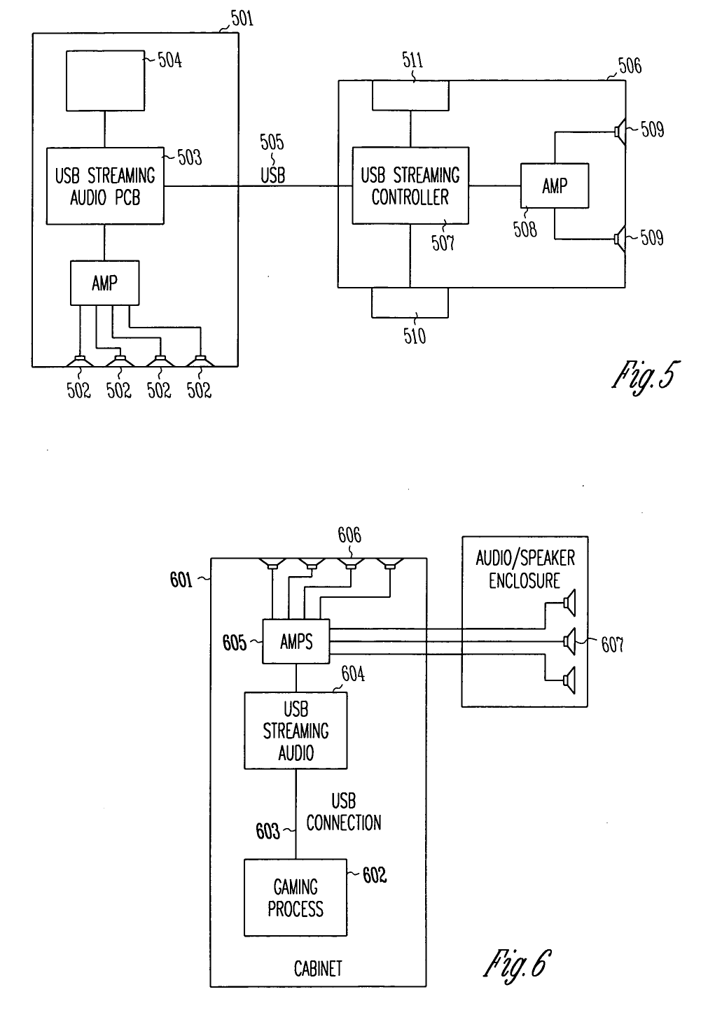

FIG. 5 shows a block diagram of the components incorporated in the audio chair apparatus coupled to the streaming audio USB device of FIG. 4. The computerized wagering game chassis at 501 contains two audio channels coupled to speakers 502, such that each audio channel is coupled to each of a woofer configured to create low frequency sound and a tweeter designed to produce high frequency sounds. Two pair of woofers and tweeters are shown at 502, and convert left and right channel audio information into left and right channel audible sound.

The USB streaming audio circuit board 503 contains an audio processor and a streaming USB interface operable to send streaming audio data over a USB connection 505 to the audio chair assembly featuring a streaming audio USB device 506. The streaming audio USB signal is received in the USB streaming controller module 507, which includes a streaming USB receiver circuit and an audio codec or digital-to-analog converter. The USB streaming controller module outputs left and right analog surround sound signal that is routed to a two-channel amplifier 508, and to the tactile transducer 510 mounted to the audio chair assembly. The amplifier 508 is coupled to left and right surround channel speakers 509, which produce sound to the left and right rear of the game player's head when seated in the audio chair 403 of FIG. 4. In other embodiments, a similar configuration is used with external enclosures other than the audio chair of FIG. 1, such as a display sign or overhanging speaker assembly.

The streaming USB controller module's audio codec is further coupled to an auxiliary audio source 511 in some embodiments, which is controlled by the computerized wagering game via commands carried over the USB connection 505. The audio source 511 in one embodiment is a compact disc or DVD player, and audio is selected at the direction of the computerized wagering game by sending track or other identifying information to the source 511 via such control signals. The audio produced by the auxiliary audio source 511 is routed to a controller such as the USB streaming controller 507, and which routes the audio signal produced to the speakers 509 or 502 as directed by the streaming audio circuit assembly 503.

In other embodiments, the USB streaming audio interface and amplifiers are not in an external enclosure, but are located within the wagering game machine cabinet. FIG. 6 shows an example of such a wagering game system. Wagering game cabinet 601 encloses a gaming processor 602 operable to conduct a wagering game, and is coupled via a USB connection 603 to USB streaming audio device 604. The USB streaming audio device 604 is coupled to amplifiers 605, such as via analog audio channel connections or digital audio connections such as SPDIF for AES/EBU digital audio signals. The amplifier is in turn coupled to in-cabinet speakers 606, as well as to external speakers 607, which are in some embodiments contained in another enclosure such as a speaker cabinet or audio chair.

These examples illustrate how a streaming audio USB device can be employed in conjunction with a computerized wagering game system to provide one or more channels of sound. The embodiments presented here show how audio can be streamed via a USB connection to a streaming audio receiver coupled via USB as a way to provide flexibility and expandability in a computerized wagering game system architecture. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the example embodiments of the invention described herein. It is intended that this invention be limited only by the claims, and the full scope of equivalents thereof.

1. A computerized wagering game system, comprising:
a gaming module comprising a processor and gaming code which is operable when executed on the processor to present a wagering game on which monetary value can be wagered, and further comprising at least one audio channel operable to produce streaming audio;
a Universal Serial Bus (USB) port, operable to couple the gaming module to at least one USB device; and
a USB audio module coupled to the gaming module via the USB port, and further operable to receive streaming audio from the gaming module and to play the streaming audio through the at least one audio channel.

2. The computerized wagering game system of claim 1, wherein the USB audio module is further operable to detect the presence of an external speaker assembly, and to report the presence of the external speaker assembly to the gaming module.

3. The computerized wagering game system of claim 1, wherein the USB audio module is further operable to receive an audio signal via at least one audio input other than the gaming module.

4. The computerized wagering game system of claim 1, wherein the USB audio module is operable to receive streaming audio from the gaming module via a USB streaming controller, which is coupled to at least one digital-to-analog converter.

5. The computerized wagering game system of claim 4, wherein the digital-to-analog converter is further coupled to an audio amplifier.

6. The computerized wagering game system of claim 5, wherein the audio amplifier is coupled to at least one speaker.

7. The computerized wagering game system of claim 5, wherein the at least one digital-to-analog converter is an audio codec.

8. The computerized wagering game system of claim 5, wherein the audio codec is further operable to receive an analog audio input signal.

9. The computerized wagering game system of claim 1, wherein the streaming audio comprises one of SPDIF, PCM, AES/EBU, Dolby Digital (AC3), DTS, or Intel HD Audio encoded digital audio.

10. The computerized wagering game system of claim 1, wherein the USB audio module is further operable to receive firmware from the gaming module.

11. The computerized wagering game system of claim 1, wherein the USB audio module is further operable to control at least one audio amplifier coupled to the USB audio module.

12. A method of operating a computerized wagering game machine, comprising:
presenting a wagering game upon which monetary value can be wagered; and
sending streaming audio via a USB port of the computerized wagering game machine to a streaming audio USB device.

13. The method of claim 12, wherein the streaming audio comprises one of SPDIF, PCM, AES/EBU, Dolby Digital (AC3). DTS, or Intel HD Audio encoded digital audio.

14. The method of claim 12, further comprising sending firmware to the streaming audio USB device via the computerized wagering game's USB port.

15. The method of claim 12, further comprising sending an amplifier control signal to the streaming audio USB device via the computerized wagering game's USB port.

16. The method of claim 15, wherein the amplifier control signal comprises an amplifier volume control signal.

17. The method of claim 12, further comprising detecting the presence of an audio chair coupled to the streaming audio USB device via the USB port of the computerized wagering game machine's USB port.

18. The method of claim 15, further comprising controlling at least one audio input coupled to the streaming audio USB device other than the gaming module.

19. A streaming audio USB module, comprising:
a USB port operable to couple the streaming audio USB module to a computerized wagering game system operable to present a game of chance upon which monetary value can be wagered;
a streaming USB controller operable to receive streaming USB audio data from the computerized wagering game; and
a digital-to-analog converter coupled to the streaming USB controller and operable to receive

20. The streaming audio USB module of claim 19, further comprising at least one audio amplifier, wherein the audio amplifier is coupled to an analog output of the digital-to-analog converter.

21. The streaming audio USB module of claim 19, wherein the audio amplifier is coupled to at least one speaker.

22. The streaming audio USB module of claim 19, wherein the digital-to-analog converter is an audio codec.

23. The streaming audio USB module of claim 22, wherein the audio codec is further operable to receive an analog audio input signal.

24. A machine-readable medium with instructions coded thereon, the instructions when executed operable to cause a computerized wagering game system to:
present a wagering game upon which monetary value can be wagered; and
send streaming audio via a USB port of the computerized wagering game machine to a streaming audio USB device.

25. The machine-readable medium of claim 24, the instructions further operable when executed to cause the computerized wagering game system to send an amplifier control signal to the streaming audio USB device via the computerized wagering game's USB port.

26. The machine-readable medium of claim 25, wherein the amplifier control signal comprises an amplifier volume control signal.

27. The machine-readable medium of claim 24, wherein the streaming audio comprises one of SPDIF, PCM, AES/EBU, Dolby Digital (AC3), DTS, or Intel HD Audio encoded digital audio.

28. The machine-readable medium of claim 24, the instructions further operable when executed to cause the computerized wagering game system to send firmware to the streaming audio USB device via the computerized wagering game's USB port.

29. The machine-readable medium of claim 24, the instructions further operable when executed to cause the computerized wagering game system to detect the presence of an audio chair coupled to the streaming audio USB device via the USB port of the computerized wagering game machine's USB port.

30. The machine-readable medium of claim 24, the instructions further operable when executed to cause the computerized wagering game system to control at least one audio input coupled to the streaming audio USB device other than the gaming module.
